(19) United States
(12) Patent Application Publication
(10) Pub. No.: US 2023/0170616 A1
(43) Pub. Date: Jun. 1, 2023

(54) ONE-PART ANTENNA CORE

(71) Applicant: Neosid Pemetzrieder GmbH & Co. KG, Halver (DE)

(72) Inventors: Nikolaj ZULUN, Halver (DE); Christian DEBUS, Halver (DE)

(21) Appl. No.: 17/920,240

(22) PCT Filed: Apr. 21, 2021
(86) PCT No.: PCT/EP2021/060320

§ 371 Date: Oct. 20, 2022

(30) Foreign Application Priority Data
Apr. 22, 2020 (DE) 10 2020 110 898.2

(51) Int. Cl. H01Q 7/06

(52) U.S. Cl. CPC H01Q 7/06

(57) ABSTRACT

A 3D antenna including three coil windings arranged substantially orthogonal to one another and made from electrically conductive wire and ferromagnetic antenna core with coil regions for receiving the coil windings. Winding-on points for starting to wind the wire onto the antenna core are formed as a single part with the antenna core.

This application is a national stage filing of International (PCT) Application No. PCT/EP2021/060320, corresponding to International Publication No. WO 2021/214104 filed on April 21, 2021, which in turn claims priority to German Application No. 10 2020 110 898.2 filed on April 20, 2020. The entire contents of both of those applications are hereby incorporated by reference.

The present disclosure concerns a 3D antenna having three essentially mutually orthogonally arranged coil windings of electrically conductive wire and a ferromagnetic antenna core with coil regions for accommodating the coil windings. Another object is a method for producing a 3D antenna with three mutually orthogonally arranged coil windings of electrically conductive wire and a ferromagnetic antenna core with coil regions for accommodating the coil windings.

### BACKGROUND

The disclosed device is used in the generation, transmission and detection of magnetic fields as a receiving and/or transmitting antenna, such as used in the mobile phone region, in keyless access control systems or in magnetic positioning systems. In order to enable directionally accurate reception and transmission in three-dimensional space, a generic 3D antenna has three mutually orthogonally arranged coil windings. Each of these coil windings made of electrically conductive wire forms a separate coil, which reacts most sensitively to incident EM radiation along its longitudinal direction, around which the wire spirals, and can emit most strongly in this direction. Due to the essentially mutually orthogonal orientation of the coil windings, each coil is aligned along a different Cartesian spatial direction. The combination of orthogonal coil windings can cover the three-dimensional space for receiving and transmitting depending on the direction.

With the same dimensions of one of the coil windings, the sensitivity and transmission strength of this coil winding is increased by a ferromagnetic antenna core inside the coil winding. Likewise, with the same sensitivity and transmission strength, the structural form of the coil winding with the antenna core can be reduced compared to a coreless coil winding. In order to save additional installation space for a generic 3D antenna, a common antenna core is used for the three coil windings. This antenna core has coil regions which serve to accommodate the orthogonal coil windings.

In the case of 3D antennas known from the prior art, frame-like or board-like supporting bodies made of insulating material are used. These supporting bodies accommodate the antenna core and the coil windings in order to stabilize them when installed in a device. The supporting body also allows fastening of the wire, wherein the wire is also wound over the supporting body in sections.

In order to be able to contact the wire electrically when installing the 3D antenna in a circuit, electrically conductive, usually pin-like contact points are also inserted into the supporting bodies, which also serve to fasten the wire. The starting ends of the wires leading to the antenna core and the ends of the wires leading away from the antenna core are soldered to these contact points in order to attach them and to establish an electrically conductive connection between the contact point and the wire and thus the respective coil winding. The coil windings can then be electrically contacted via the contact points when the 3D antenna is installed. For this purpose, the 3D antenna is electrically integrated into a circuit via the contact points.

Such 3D antennas with a supporting body are complex in their production, since the conductive contact points must be introduced separately into the insulating supporting body, the supporting body and the antenna core must be connected to each other and electrically conductive connections between the wires and the contact points must be made separately. Only after these various production steps is the 3D antenna ready for installation. The production of such a 3D antenna is material-consuming and time-consuming as well as associated with high process costs.

### SUMMARY

An object is therefore to specify a 3D antenna which can be produced in a simple way.

This object is achieved in a device of the type mentioned above in that winding-on points for winding on the wire onto the antenna core are formed in one piece with the antenna core.

The wire can be easily wound on at the winding-on points. When starting to wind on, the wire is wound around one of the winding-on points for attachment to the antenna core. Starting to wind on allows the wire to be attached to the antenna core without the need for a joining agent for fastening, such as an adhesive or solder, between the wire and the winding-on point. Nevertheless, a joining agent can be used to additionally secure the winding. The coil windings are wound directly on the antenna core and can be single-layer and/or multi-layered. Due to the winding-on points formed in one piece with the antenna core, a separate supporting body can be dispensed with.

The coil windings overlap in sections in an advantageous way. In the case of overlapping coil windings, a first coil winding can form the innermost coil winding on the antenna core side, a second coil winding the outermost coil winding on the antenna core side and a third coil winding the middle coil winding located between the innermost and the outermost coil windings. The innermost coil winding can be the first and the outermost coil winding the last coil winding wound on the antenna core. In one case, the coil first winding wound on the antenna core at each overlap is the innermost coil winding and the last coil winding wound on the antenna core at each overlap is the outermost coil winding.

In this context, it may be advantageous if the antenna core has six, in particular plate-like, core elements. The antenna core can be assembled from the core elements. The core elements may be arranged together without a supporting body or an additional frame and/or can be connected to each other, in particular glued or encapsulated.

Alternatively, it may be advantageous if the antenna core is formed in one piece. A one-piece antenna core can be produced as a single unit, in particular cast, sintered or made from the solid, such as cut or milled.

In an advantageous embodiment, the antenna core is formed as a hollow core, in particular in one piece. With a hollow core, material of the antenna core can be saved. The total weight of the 3D antenna can be reduced. The efficiency of the 3D antenna can be kept constant even when using a hollow core compared to a full core. The antenna core formed as a hollow core may have one or more non-closed side surfaces, i.e. a topside, underside and/or outer side. In particular, two opposing side surfaces of the antenna core can be formed open, wherein in particular antenna core material may be present only in the edge region of these side surfaces. To stabilize the hollow antenna core, a stabilization floor may be provided in the manner of an intermediate floor, which runs in particular parallel to non-closed side surfaces. The stabilizing floor can be positioned at any height. The positions of the coil windings and the stabilizing floor can be matched to each other. In this way, a symmetrical magnetic field shape can result in all axes. In particular, the stabilizing floor may run transverse to an axis, in particular to the z-axis, and may be positioned along the middle plane of the coil around that axis.

Especially with a hollow core, it may be advantageous if the wall thickness of the antenna core is in the range of 1 mm to 3 mm, in particular 1.5 mm.

The coil windings can be parts of antenna windings which have wire bindings and at least one transition winding for connecting the coil winding to one of the wire bindings. The antenna winding consists of a wire wound on the antenna core, especially from the starting end of the wire to the end of the wire. After winding onto the antenna core, the wire of the antenna winding can be separated into several wire segments, especially during the further production process of the 3D antenna. Between the start and end of the wire, wire openings can occur, which form the start and/or the end of a wire segment. The separated wire segments can be further conductively connected to each other. The wire bindings of the antenna windings are formed by the sections of the wire of the antenna winding wrapped around the winding-on points.

Each coil winding can be part of its own antenna winding. Here, it may be advantageous if the 3D antennas have at least three antenna windings, in particular electrically isolated from each other. The antenna windings may be electrically isolated from each other by the use of insulated wires and/or by the electrically insulating antenna core.

According to a design embodiment, it is proposed that the winding-on points are stud-shaped, in particular with a U-shaped cross-section. Stud-shaped winding-on points can protrude from the other areas of the antenna core. By protruding the winding-on points, the wire can be wound around the winding-on points in a particularly simple way to produce the wire bindings.

On the antenna core, two winding-on points may be provided for each antenna winding. The winding-on points may be distributed over the circumference of the antenna core, in particular over the circumference of the antenna core. Due to the arrangement distributed over the circumference, the winding-on points can be arranged in the manner of a trunnion of the antenna core, in particular located at an end region of the antenna core. The winding-on points may be arranged in a plane extending parallel to one of the coil windings.

The wire may be wound around the circumferential region of the winding-on point, in particular in a circumferential groove. Along its circumference, at least one winding-on point may have a U-shaped cross-section. The U-shaped cross-section allows the contact region between the winding-on point and the wound-on wire to be increased to provide a better grip.

In an advantageous manner, the wire of the wire binding is severed at the winding-on point. The wire can be severed, in particular cut or punched through, in such a way that in addition to a starting end of the wire and a wire end of the wire forming the winding, additional wire openings are created at which the wire is severed. The wire can consist of several wire segments after severing, which form several open wire loops, especially in the wire binding. The wire binding can be formed in this way in the manner of an open wire binding. Compared to a 3D antenna with a closed wire binding, in which the wire binding acts like another coil winding, electrical eddy current losses and the effects of inductive coupling can be reduced or prevented. Due to the severing, the quality of the 3D antenna can be improved.

The winding-on point can have a winding-on recess. The wire can be pressed into the winding-on recess during winding-on and/or afterwards, so that the wire binding wire can engage in the winding-on recess to secure the wire. The winding-on recess can provide an insertion opening in the manner of a punch die for a separating tool for severing the wire of the wire binding. The separating tool can interact with the punch-die-like winding-on point in the manner of a punch. By the insertion, the wire can be tightened in its circumference due to a tensile load, so that contact with the shape of the winding-on point is achieved. In this way, a tightly fitting wire of the wire binding can be achieved. In the case of a 3D antenna with several winding-on points, mutual coplanarity of the wire bindings can be achieved in this way, in particular at the underside of the antenna core.

In this context, it may be advantageous if the winding-on recess is pocket-shaped, continuous and/or slot-shaped. A pocket-shaped winding-on recess can essentially be formed by four walls and a floor in the manner of a sink. In this way, the pocket-shaped winding-on recess can be designed to be open on one side. A separating tool for cutting the winding-on wire can thus enter the winding-on recess along one direction through the open side. A continuous winding-on recess can essentially be bounded by four walls. In contrast to the pocket-shaped winding-on recess, it has no bounding bottom. A separating tool for cutting the winding-on wire can thus enter the continuous winding-on recess along two opposite directions through the open side. A slot-shaped winding-on recess can be bounded by three walls. In addition, the slot-shaped winding-on recess may be bounded by a floor. In this way, the slot-shaped winding-on recess can be formed open on at least two sides. In this way, a separating tool for cutting the winding-on wire can be inserted into the winding-on recess through the open sides. An acceptance region regarding the direction of insertion can be provided to allow for easier insertion of the separating tool. At least two open sides can be essentially perpendicular to each other. In particular, the separating tool can enter the winding-on recess along a direction between the surface normal of two open sides. The winding-on recess can be partly pocket-shaped and partly slot-shaped. In the case of a partly pocket-shaped and partly slot-shaped winding-on recess, one of the walls can only partially bound the winding-on recess. In this way, a winding-on recess can be achieved which is slot-shaped in an upper region and pocket-shaped in a lower region.

In this context, it is particularly advantageous if the winding-on recess at the winding-on point runs radially inwards along a radial direction. A radially inward opening recess allows particularly simple tool guidance of the separating tool when severing the winding-on wire. In particular, tilting of the separating tool relative to the winding-on point can be avoided when severing the wire. The radial direction can be in the direction of a longitudinal axis of the winding-on point. In the case of a winding-on point with a round or oval cross-section, the radial direction points along the radius towards the interior of the cross-sectional surface. In the case of a winding-on point with an essentially square or rectangular cross-section, the radial direction points parallel to a normal to a side of the cross-section towards the center of the cross-section. In the case of an essentially square winding-on point, the winding-on recess can be centered along a side edge or a side surface of the winding-on point. The winding-on recess can extend radially inward along the radial direction along a third, or along half, of the maximum dimension of the winding-on point. The radial directions of the winding-on recesses of several, and in one case all, winding-on points can be oriented parallel to each other.

Particularly, the winding-on recess can taper in the radial direction. In particular, in the case of a winding-on point with an essentially circular or oval cross-section, the taper in the radial direction may be formed in the manner of an in particular blunted circular cut-out. The winding-on recess can taper in the radial direction along one or two axes essentially orthogonal to the radial direction.

According to a design embodiment, it is proposed that the wire severed in the winding is crimped, in particular bent into the winding-on recess. By crimping, the severed wire can be attached to the winding-on point. By bending the severed wire into the winding-on recess, the wire can be attached to the winding-on point in a particularly simple way. The edge of the winding-on recess can be formed as a bending edge, over which the severed wire is bent into the winding-on recess. The edge of the recess formed as a bending edge may be deburred, in particular provided with a chamfer or rounded. A deburred bending edge prevents damage to the wire during bending. For crimping and in particular for bending the wire in, a crimping tool in the style of a stamp can be inserted into the winding-on recess.

It is further advantageous if the winding-on point has at least one fold. By means of a fold, the winding-on can also be secured against slipping at the winding-on point. The fold may advantageously be arranged at the end of the winding-on point lying along its longitudinal axis on the outside of the antenna.

The winding-on points may have a circumferential groove running along their circumference. The circumferential groove can accommodate the wire when starting to wind.

The winding-on point can taper along a direction that points away from the antenna core along a longitudinal axis of the winding-on point. Advantageously, the winding-on point may have a circumferential groove, which is bounded in particular on one side by a core foot and on the other side by a fold. In this way, an essentially rectangular circumferential groove can be achieved.

The winding-on point can widen along a direction that points away from the antenna core along a longitudinal axis of the winding-on point. Advantageously, the winding-on point may have a circumferential groove bounded on one side by a core foot and on the other side by the outwardly widening shape of the winding-on point. In this way, a circumferential groove with an essentially triangular cross-section can be achieved.

In an embodiment, the antenna core has winding-on points of different winding-on point types, in particular two different winding-on point types. The winding-on point types may differ from each other in their shape. This is an advantage for automatic winding on. The winding-on points of a first type of winding-on point can be used to wind on a region of the wire of an antenna winding adjacent to the starting end of the wire. The winding-on points of a second type of winding-on point can be used to wind on a region of the wire of an antenna winding leading to the wire end. Advantageously, one of the types of winding-on points, in particular the second, has no fold. A winding-on point with no fold is an advantage for manual winding on.

In a development, it is provided that the antenna core has at least one production-supporting geometry, in particular a stud, a groove, a notch and/or a recess. A production-supporting geometry can enable easy production of the 3D antenna. A production-supporting geometry can, for example, enable easy winding on by making hard-to-reach parts of the antenna core more easily accessible due to the geometry. In particular, production by means of winding devices, such as winding machines or winding robots, can be made possible or improved by production-supporting geometries. Automation of the production of the 3D antenna can be improved in this way.

With an embodiment, it is provided that the antenna core has a centering aid, in particular a centering groove arranged diagonally and/or on the underside of the antenna core. The centering aid can be used to center the antenna core during production, in particular during the winding of the antenna windings on the antenna core and/or during the severing of the winding-on wire. The centering aid can allow a more precise orientation of the antenna windings on the antenna core during winding. In particular, when using a winding device, such as a winding machine or a winding robot, the centering aid can interact with appropriate centering means of the winding device for centering the antenna core, especially when rotational processes with the antenna occur in the production process, e.g. when winding an antenna winding around the z-axis. Due to an arrangement of the centering aid in one case on the underside of the antenna core, the remaining sides of the antenna core are easily accessible. The underside of the antenna core is the side via which the 3D antenna is installed, for example the side with which the 3D antenna is in contact with a circuit board. The centering aid located on the underside of the antenna core can be used for centering when installing the 3D antenna, wherein, for example, centering means of a circuit board can engage in the centering aid, or can serve to position the antenna when severing the winding.

A centering aid in the form of a diagonal centering groove can run between two opposite corners of one side of the antenna core. Particularly stable centering can be carried out with the help of centering aids in the manner of crossed grooves. Crossed grooves can be formed by two grooves that essentially cross over at right angles. Diagonal and/or crossed grooves may be formed in sections. The individual sections of the grooves can be arranged in corners of the sides of the antenna core. For example, two grooves arranged in diagonally opposite corners of a side surface of the antenna core can together form a diagonal groove which is formed in sections. Likewise, four grooves arranged in pairs, whose alignment lines essentially cross at right angles, can form crossed grooves which are formed in sections.

In an advantageous manner, the winding-on points are arranged along the edge of the underside of the antenna core, in particular in the manner of a trunnion. The winding-on points can point with their longitudinal direction along a direction essentially transverse to the surface normal of the underside.

Furthermore, it may be advantageous if the antenna core has at least one receiving groove for a starting end of a wire of one of the antenna windings, in particular at the underside of the antenna core. The receiving groove can accommodate the starting end of the wire of the antenna winding so that it can be fixed in its position. In the receiving groove, the start of the wire can also be fixed, for example by a wire section of the transition winding, which runs over the starting end of the wire accommodated in the receiving groove, and/or by a joining means connecting the starting end of the wire to the receiving groove. The antenna core can have a receiving groove for each starting end of the wires of the antenna windings. In this way, the starting ends of the wires of all antenna windings can be accommodated in a fixed position. Any damage, jamming or short circuits caused by loose starting ends of wires when installing the 3D antenna can be avoided in this way.

In a further advantageous embodiment, it is provided that the antenna core has a notch at a corner, in particular to enable engagement by a winding device. The notch allows the wire to be guided precisely and close to the surface of the antenna core during winding on the antenna core. In particular, in the case of production by means of a winding device, damage to the antenna core can be avoided due to the notch. The notch may be formed in particular in the manner of a notch in the corner of the antenna core. In the case of a notch, material is missing compared to a notchless corner in the region of the common corner of all three sides of the antenna core forming the corner. The notch can be provided to simplify the winding of a coil winding running parallel to the surface normal of the underside of the antenna core.

It is further advantageous if at least one transition winding of the wire runs under a coil winding, in particular partially. The transition winding running under the coil winding can be easily fixed by the coil winding. It may be advantageous if the transition winding running under the coil winding and the coil winding belong to the same antenna winding, in particular if the coil winding runs parallel to the surface normal of the underside of the antenna core and/or forms the outermost coil winding of the 3D antenna.

According to an exemplary embodiment, the antenna core has a guide region for guiding the wire to one of the coil regions, in particular running under one of the coil windings on the antenna core side. With the guide region, the wire can be easily guided to the coil region. The guide region can be used to fix the position of the wire so that it cannot slip after winding. In particular, the guide region can partially guide the transition winding. To guide the wire, the guide region may be formed in particular in the manner of a groove or a tongue and groove. The guide region may be adjacent to a notch of the antenna core, advantageously on the winding-on point side and in particular adjacent to the end region of a notch facing the underside of the antenna. The guide region can redirect the wire from the winding-on point to the coil region. The coil winding of the antenna winding, the transition winding of which is guided by the guide region, can thus run substantially parallel to the underside of the antenna core.

In this context, it may be advantageous if the guide region has at least two guide sections. The two guide sections can run along one or more outer sides of the antenna core. There may be a winding offset between the guide sections. The guide sections can be arranged on a common outer side of the antenna core or may guide the wire around an edge of the antenna core by their arrangement on two adjacent outer sides of the antenna core. A first guide section can guide the wire towards the inside of the antenna core. A second guide section can guide the wire away from the inside of the antenna core. The first guide section can otherwise guide the wire, i.e. in addition to or instead of the guidance towards or away from the inside, essentially along a first axis of the antenna core or with an angular offset to the first axis of the antenna core, in particular of less than 10°. The second guide section can otherwise guide the wire essentially along a second axis of the antenna core, in particular transverse to the first axis. In this way, the guide sections could be inclined to the inside or outside of the core and essentially run along or with an angular offset to an axis of the antenna core.

It may be provided that the antenna core has an essentially cube-shaped geometry. With an antenna core of an essentially cube-shaped geometry, an isotropic 3D antenna can be easily achieved. The coil regions of the antenna core can be essentially the same in their dimensions. Advantageously, the three coil windings are similar, in particular essentially similar in their dimensions, their numbers of winding and/or the cross-section of the electrically conductive wire used. In this way, the three coil windings can provide an isotropic 3D coil. In combination with the essentially cube-shaped antenna core, the 3D antenna can be made isotropic. The coil windings are essentially the same if in comparison between them there are only deviations which serve to generate an isotropic 3D coil and/or an isotropic 3D antenna.

Particularly, the antenna core can have deburred edges, in particular in the coil regions. Deburred edges, also known as chamfered edges, allow a less sharp-edged transition between side surfaces of the antenna core. Deburred edges can be less susceptible to damage compared to sharp edges, i.e. essentially rectangular edges. Mechanical stress on the wire can be reduced by one or more deburred edges of the antenna core. In particular, sharp-edged windings of the wire can be avoided. The deburred edge may be rounded or have a chamfer.

From a design point of view, it may be advantageous if protrusions, in particular core feet, bound the coil regions in at least one direction. The coil regions can run along the circumferential directions of the antenna core. Each of the coil regions can be easily bounded by a protrusion along a direction that runs transversely to the respective circumferential direction. These protrusions can be core feet, which form part of the underside of the antenna core. These antenna feet can easily bound a coil region running parallel to the underside. For this purpose, the core feet can be formed as protrusions running parallel to the underside. The underside of the antenna core can have a larger cross-sectional region due to the core feet than the diametrically opposed topside of the antenna core.

It may be particularly advantageous if the winding-on points are arranged on the protrusions. In this way, the winding-on points can occupy a particularly prominent position. A simple start of winding on the wire can be made possible at the protruding winding-on points. In this way, the wire bindings at the winding-on points can form contact points on the underside of the 3D antenna, for example in order to be able to make contact with a printed circuit board.

Particularly, at least one of the coil regions can be formed in the manner of a coil channel. A coil region formed as a coil channel can guide a coil winding along the circumference of the antenna core. By guiding the coil winding in the coil channel, slipping of the coil winding on the antenna core can be avoided. In this context, it may be particularly advantageous when two coil regions are formed depending on the type of coil channel. A third coil region can only be bounded along one direction, in particular by protrusions.

In this context, it is particularly advantageous if the coil channel is formed by at least one channel recess of the antenna core, in particular between edge posts and/or core feet. A channel recess can easily form a section of the coil channel. The channel recess can be so deep that it can fully accommodate the coil winding, especially a single-layer or multi-layer coil winding. For this purpose, the channel recess may be in the region of the diameter or a multiple of the diameter of the wire used. A channel recess can be formed in the manner of a groove that accommodates the entire width of the coil winding. On each side of the antenna core, one or more channel recesses may be provided, which together form the coil channel of the coil region. A channel recess can be formed in a particularly simple way between edge posts and/or core feet. Both edge posts and core feet can protrude from the other surface areas of the antenna core, so that on one side of the antenna core, which has at least two edge posts, at least two core feet or at least one edge post and one core foot, a channel recess can be easily formed between these. Edge posts can be wall thickness increases running along an edge of the antenna core. An edge post can be formed by protrusions adjacent to each other along an edge on the sides of the antenna core sharing the edge. The stability of the antenna core can be increased with an edge post. Advantageously, the edge post joins onto a core foot of the antenna core.

In an advantageous manner, the antenna core includes or consists of a highly permeable and/or soft magnetic material. Due to the antenna core, the magnetic field of the coil winding can be easily amplified. Hysteresis losses and eddy current losses can be easily minimized by using a soft magnetic material. The antenna core can include or consist of a ferrite-plastic mixture.

In an advantageous manner, the antenna core is made of, in particular sintered, ferrite. With ferrite, high permeability of the material of the antenna core can be achieved, which is additionally increased by the use of sintered ferrite. By using a sintered ferrite, the permeability of the antenna core can be further increased. The entire antenna core can include or consist of sintered ferrite.

Furthermore, it may be advantageous if at least one winding is metallized, in particular on the underside of the antenna core. The metallized winding can be used to contact the 3D antenna during installation. The winding can be tinned. The wire of the winding can be stripped before metallization, for example mechanically or by means of a laser, or during metallization chemically and/or under the influence of temperature. All wire bindings of a coil winding, in particular all wire bindings of windings of the 3D antenna, can be metallized. An electrical connection between the individual wire loops of the wire binding of a winding can be achieved. The wire end and/or the start of the wire may be metallized together with the wire binding of the winding. A metallized wire binding of a winding on the underside of the antenna core makes it easy to install the 3D antenna in the style of an SMD component. To increase the stability of the 3D antenna on a printed circuit board, in addition to soldering the metallized wire binding of the winding, an adhesive connection can be made between the 3D antenna and the printed circuit board. The wire binding can be completely metallized, i.e. running extensively around the winding-on point. The wire of the wire binding may be metallized on the side facing away from the winding-on point, i.e. the side not adjacent to the winding-on point. Nevertheless, the wire can also be metallized on the side facing the winding-on point. In the case of metallization already taking place before severing, the wire loops can also contribute to improved stability during severing. In particular, when using a thin wire, i.e. with a diameter of essentially 300 µm and less, the stability improvement achieved by metallization can counteract unintentional tearing of the wire, in particular during severing.

With a method of the type mentioned above, to achieve the aforementioned object it is proposed that the wire is wound on winding-on points formed in one piece with the antenna core. By the winding on, an attachment of the wire to the antenna core is established without using a joining agent between the wire and the winding-on point for fastening, such as an adhesive or a solder. Nevertheless, a joining agent between the wire and the winding-on point can be used to additionally secure the wire binding. The wire, which is initially wound on a winding-on point, is wound directly onto the antenna core to wind the coil windings. The wire can then be wound on another winding-on point. The use of a separate supporting body can be dispensed with.

The features described in connection with the 3D antenna according to the disclosure can also be used individually or in combination with the method. There are the same advantages that have already been described.

In an advantageous embodiment, the antenna is produced by means of a spraying process. Mechanical post-processing, especially for deburring edges, can be dispensed with. In this way, production can be carried out more cost-effectively.

When winding the wire the antenna core can be held in a winding device by means of a centering aid, in particular a centering groove arranged diagonally and/or on the underside of the antenna core. The winding device can be a winding machine or a winding robot. By holding the antenna core by means of the centering aid, reliable and accurate winding of the wire on the antenna core can be ensured. The antenna core can be held in the winding device by means of the centering aid during the winding process of one or more entire antenna windings or only during the winding of a part of an antenna winding, such as one or more wire bindings, one or more transition windings and/or the coil winding.

It is further advantageous if a starting end of a wire is clamped in a receiving groove by the wire binding and/or the transition winding when winding on. By the clamping, during which in particular the region of the wire forming the wire binding and/or the transition winding is wound over the starting end of the wire, the starting end of the wire can be fixed in the receiving groove in a simple way. Loosening of the starting end of the wire can be prevented in this way. The wire binding and/or the transition winding may be parts of the antenna winding which are formed by the wire associated with the starting end of the wire.

It has also proven to be advantageous if the winding device engages in a notch at a corner of the antenna core when winding at least one of the antenna windings. Due to the engagement in the notch, the wire can be wound particularly close to the surface of the antenna core. The precision when winding the antenna winding can be increased.

It is possible that the winding device guides the wire of at least one transition winding over a guide region to the coil region. Due to guidance of the wire of the transition winding over the guide region of the antenna core, the wire can be stabilized in its position during winding. Slipping of the wire during winding of the coil winding around the coil region of the antenna core can be prevented.

In this context, it is particularly advantageous if the winding device winds the coil winding over the transition winding guided in the guide region. The transition winding can be further fixed by the coil winding in this way, so that no unwanted displacement of the transition winding on the antenna core takes place after completion of the winding.

The winding-on wire wound around the winding-on point can be severed. The wire can be severed, in particular cut through or punched through, in such a way that in addition to a starting end of the wire and a wire end of the wire forming the winding, additional wire openings are created at which the wire is severed. The wire can include or consist of several pieces of wire after severing, which form several open wire loops, especially in the wire binding. In this way, the wire binding can be produced in the manner of an open wire binding. Compared to a 3D antenna with a closed wire binding, electrical eddy current losses and the effects of inductive coupling can be reduced or prevented. Due to the severing, the quality of the 3D antenna can be improved.

The antenna core can be held when severing the wire by means of a centering aid, in particular a centering groove arranged diagonally and/or at the underside of the antenna core. A positionally accurate and reproducible interaction of a separating tool with the winding-on point can be achieved in a simple way.

In an advantageous manner, the wire binding is severed after completion of one or all windings of the 3D antenna. In this way, the winding process of the winding can be carried out first. In particular, when using a winding device, such as a winding machine or a winding robot, the winding process can first be completed with the winding device before the wire binding is severed in a further production step. The severing of the winding can be carried out by means of a separating device which is separate from the winding device. Nevertheless, a separating tool with severing of the wire binding can be part of the winding device.

The wire of the wire binding wound around the winding-on point can be metallized, in particular fully or only on the underside of the antenna core. An electrical connection can be created by the metallization when installing the 3D antenna. The 3D antenna can be prepared by the metallization for installation by means of a soldering process. The wire can be stripped in the region of the wire binding, especially region-by-region. The stripping of the wire can be carried out mechanically by means of a laser using a temperature action and/or by means of a chemical flux. A metallization of the wire, in particular complete metallization extending around the winding-on point, can be realized with a soldering bath, in which the winding-on point is immersed with the wire wound around it.

Furthermore, it is proposed that the winding-on wire wrapped around the winding-on point is severed after metallization. The severing can be carried out immediately after metallization or after one or more further processing steps during the production of the 3D antenna. Especially with a thin wire, i.e. with a diameter of essentially 300 µm and less, complete metallization before severing has a stabilizing effect on the wire. The wire loops of the wire binding can be connected to each other by metallization, so that, in particular, a thin wire does not get stuck after passing through a separating tool and is not unintentionally deformed when the separating tool is moved further after the severing. The severing process can be controlled better in this way.

Furthermore, it may be advantageous if the wire severed from the winding-on point is crimped. The crimping tool used for crimping can essentially have an outer contour complementary to the inner contour of the winding-on recess. In addition, between the crimping tool and the winding-on recess, a free space may be provided for receiving the wire during crimping. The wire can be secured to the wire binding by the crimping. The wire can be crimped after severing or at the same time as the severing.

Furthermore, the winding-on wire can be pressed into a winding-on recess for severing. When pressed into the winding-on recess, the wire can be cut through or punched through by a separating tool. For this purpose, the separating tool can interact like a punch with the winding-on recess like a die. Advantageously, the wire is crimped at the same time during the severing, in particular being bent into the winding-on recess. The start of the wire or the wire end can be easily fixed in the winding-on recess together with the wire openings caused by the severing. The severing and simultaneous crimping of the wire can be achieved by a combined separation and crimping tool, which can be part of a winding device.

Particularly, a separating tool adapted to the winding-on recess can be used to sever the wire wound around the winding-on point. The outer contour of the separating tool can essentially be complementary to the inner contour of the winding-on recess. The separating tool may also have a cutting edge for severing, which enters the winding-on recess for severing. The separating tool and the winding-on recess can work together like two forms of a die. In an advantageous manner, the separating tool can be in the form of a type of combined separation and crimping tool.

### BRIEF DESCRIPTION OF THE DRAWINGS

Further details and advantages of a 3D antenna according to an embodiment and a method for producing such a 3D antenna will be explained below by way of example on the basis of the exemplary embodiments schematically presented in the figures. In the figures:

FIG. 1a shows a view of a first embodiment of an antenna core of a 3D antenna;

FIG. 1b shows another view of a first embodiment of an antenna core of a 3D antenna;

FIG. 1c shows another view of a first embodiment of an antenna core of a 3D antenna;

FIG. 1d shows another view of a first embodiment of an antenna core of a 3D antenna;

FIG. 1e shows another view of a first embodiment of an antenna core of a 3D antenna;

FIG. 2 shows a perspective view of the antenna core in the region of a notch;

FIG. 3 shows a perspective view from diagonally below to the antenna core according to FIGS. 1a-1e;

FIG. 4 shows a perspective view from diagonally above to the antenna core according to FIGS. 1a-1e;

FIG. 5a shows a view of a 3D antenna with an antenna core according to a second embodiment;

FIG. 5b shows another view of a 3D antenna with an antenna core according to a second embodiment;

FIG. 5c shows another view of a 3D antenna with an antenna core according to a second embodiment;

FIG. 5d shows another view of a 3D antenna with an antenna core according to a second embodiment;

FIG. 5e shows another view of a 3D antenna with an antenna core according to a second embodiment;

FIG. 6 shows a perspective view from diagonally below to the antenna core according to FIGS. 5a-5e;

FIG. 7 shows a perspective section of the 3D antenna according to FIGS. 5a-5e in the region of a notch with a hidden coil winding;

FIG. 8a shows a view of the 3D antenna according to FIGS. 5a-5e in the region of the notch with a partial coil winding;

FIG. 8b shows another view of the 3D antenna according to FIGS. 5a-5e in the region of the notch with a partial coil winding;

FIG. 9 shows a perspective view of the 3D antenna according to FIGS. 5a-5e in the region of winding-on points; and

FIG. 10 shows a perspective view of the winding-on points according to FIG. 9 from a perspective from diagonally below.

### DETAILED DESCRIPTION

3D antennas 100 are used for receiving and/or transmitting electromagnetic signals in various devices, in particular in the mobile radio range. For this purpose, such 3D antennas 100 have three essentially mutually orthogonally arranged coil windings 101.2, 102.2, 103.2 of electrically conductive wire 111, 112, 113, which are wound around a ferromagnetic antenna core 1.

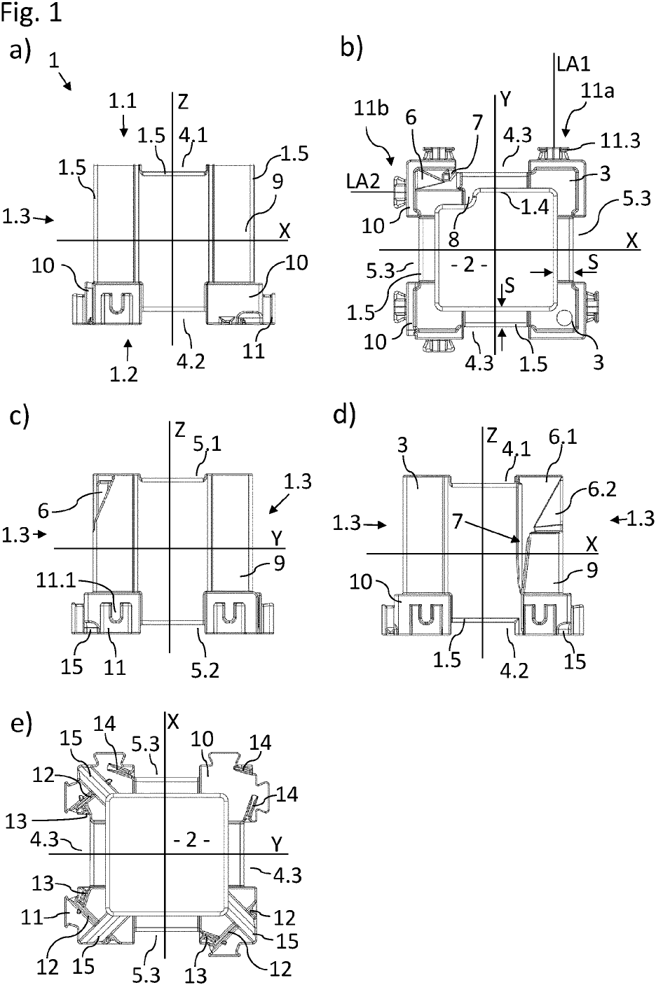

In FIG. 1 to FIG. 4, a first embodiment of an antenna core 1 for such a 3D antenna 100 is shown. In order to be able to better recognize the individual features of the antenna core 1, no antenna windings 101, 102, 103 are initially shown in these figures.

FIG. 1 shows the essentially cube-shaped antenna core 1 from different perspectives along the x-axis X, y-axis Y and z-axis Z of the antenna core 1. FIG. 1a shows a view of an outer side 1.3 of the antenna core 1 along the y-axis Y. Compared to FIG. 1a, FIG. 1b is rotated by 90° around the x-axis X and shows the topside 1.1 of the antenna core 1. Compared to FIG. 1a, the antenna core 1 in FIG. 1c is rotated by 90° around the z-axis Z, so that it shows the outer side 1.3 of the antenna core 1 along the z-axis Z. Starting from FIG. 1c, the antenna core 1 for the view according to FIG. 1d is again rotated by 90° around the z-axis Z, so that in this the outer side 1.3 of the antenna core 1 opposite to FIG. 1a along the y-axis Y is shown. Starting from the representation in FIG. 1c, the antenna core 1 in the view according to FIG. 1e is rotated by 90° around the y-axis Y, so that in FIG. 1e the underside 1.2 of the antenna core 1 is shown.

In the underside edge region of the outer sides 1.3, the antenna core 1 has winding-on points 11, onto which the wires 111, 112, 113 of which the coil windings 101.2, 102.2, 103.2 consist can be wound for fastening. The winding-on points 11 are formed in one piece with the antenna core 1. The use of additional supporting bodies, frames or circuit boards for fastening the wire 111, 112, 113 can thus be dispensed with. The winding-on points 11 are stud-shaped, wherein they protrude along one of the axes X, Y from the outer sides 1.3 of the antenna core 1.

The winding-on points 11 of the antenna core 1 are formed by two winding-on point types 11a, 11b of slightly different geometry. A first winding-on point type 11a tapers along the direction away from the antenna core 1 along a longitudinal axis LA1 of the winding-on point 11, as can be seen in particular in FIG. 1b. This winding-on point type 11a has a fold 11.3 running to its end region and closing it towards the outside of the antenna core. This winding-on point type 11a is particularly suitable for winding on the region of the wire 111, 112.1, 113.1 adjoining the starting end of the wire 111, 112, 113.

The second winding-on point type 11b, on the other hand, widens along a longitudinal axis LA2 of the winding-on point 11 away from the antenna core 1, as can also be seen in FIG. 1b. With this type of winding-on point 11b, it is not necessary to provide for a fold 11.3, but this winding-on point type 11b may also have such a fold 11.3.

The winding-on points 11 are distributed along the circumference of the antenna core 1 and arranged in a common plane in the manner of a trunnion. In order to enable particularly simple winding on of the wire 111, 112, 113 at the winding-on points 11, the winding-on points 11 along the x-axis X or the y-axis Y to the outside of the antenna are the outermost parts of the antenna core 1. For this purpose, the winding-on points 11 are arranged on core feet 10. The core feet 10 in the form of protrusions are arranged at the corners of the underside 1.2 of the antenna core 1 and form both protrusions of the underside 1.2 and the respective outer sides of the antenna core 1 adjacent to these corners 1.3.

In order to receive the wire 111, 112, 113 during winding on, the winding-on points 11 have circumferential grooves 11.2 running along their circumference. In the case of winding-on point type 11a, this circumferential groove 11.2 is bounded on one side by the fold 11.3 and on the other side by the core foot 10. This results in an essentially rectangular circumferential groove 11.2.

With the winding-on point type 11b, the circumferential groove 11.2 is also bounded on one side by the core foot 10. The remaining boundary of the circumferential groove 11.2 results from the outwardly widening shape of the winding-on point 11. In this way, a circumferential groove 11.2 with an essentially triangular cross-section is achieved.

The winding-on points 11 which point to the outside of the antenna core have an essentially U-shaped cross-section along the circumferential groove 11.2 and transversely to their longitudinal axes LA1, LA2. With its U-shaped cross-section, the winding-on point 11 surrounds a slot-shaped winding-on recess 11.1. The wire 111, 112, 113 wound on the winding-on point 11 is pressed into this winding-on recess 11.1. In this way, the winding-on recess 11.1 acts as a trap for the wire 111, 112, 113. This results in a more secure attachment of the wire 111, 112, 113 to the antenna core 1.

In addition to the core feet 10, the antenna core 1 also has further protrusions in the manner of edge posts 3 along the edges 1.5 of adj acent outer sides 1.3 of the antenna core 1. These edge posts 3 run along the edges of the antenna core 1 running parallel to the z-axis Z. The edge posts 3 serve to stabilize the antenna core 1, which is in the form of a hollow core.

In the direction of the underside 1.2, the edge posts 3 merge into the core feet 10. Based on the edge posts 3, the core feet 10 have larger dimensions, so that the core feet 10 represent a protrusion relative to the edge posts 3.

As can also be seen in FIGS. 3 and 4, the antenna core 1 is in the form of a hollow core with open surfaces at the topside 1.1 and on the underside 1.2. To stabilize the antenna core 1, it has a stabilization floor 2 arranged between the topside 1.1 and the underside 1.2, which runs parallel to the topside 1.1 and the underside 1.2. This stabilizing floor 2 is arranged in the middle of the antenna core 1, i.e. at half the distance between topside 1.1 and underside 1.2. The stabilizing bottom 2 contributes to the stiffness of the outer sides 1.3 of the antenna core 1 against deformations directed towards the inside of the antenna core.

FIG. 1b and FIG. 1e allow a view of the interior of the antenna core 1 through the open topside 1.1 and underside 1.2, respectively. Between the outer sides 1.3 and the inner sides 1.4, the antenna core 1 has a minimum wall thickness S in the range of 1 to 3 mm, in particular of 1.5 mm. To stabilize the antenna core 1 in areas in which, for example, there are recesses or notches 6 on the outer side 1.3, the inner side 1.4 has an inner protrusion 8 directed towards the inside of the antenna core. With this inner protrusion 8 in the form of a displacement towards to the inside of the antenna core, a minimum wall thickness S is ensured or maintained.

In addition to the core feet 10 and the edge posts 3, the antenna core 1 has several coil regions 4, 5, 9. The coil windings 101.2, 102.2, 103.2 are wound on these coil regions 4, 5, 9 and are thus accommodated by the coil regions 4, 5, 9.

The coil region 9 running along the z-axis Z is bounded on one side towards the underside 1.2 by the core feet 10. Towards the topside 1.1, the coil region 9 runs from the core feet 10 to a guide region 7, which is described in more detail below.

The other two coil regions 4, 5 are formed in the manner of coil channels. These coil channel-like coil regions 4, 5 are composed of several channel recesses 4.1, 4.2, 4.3, 5.1, 5.2, 5.3. These channel recesses 4.1, 4.2, 4.3, 5.1, 5.2, 5.3 are lower lying regions of the topside 1.1, the underside 1.2 and/or the outer sides 1.3 of the antenna core 1. These channel recesses 4.1, 4.2, 4.3, 5.1, 5.2, 5.3 are bounded on their sides and thus form a channel along which the wire 111, 112, 113 can be guided during winding of the coil windings 101.2, 102.2.

The channel recesses 4.3, 5.3 running along the z-axis Z of the antenna core 1 are formed between the edge posts 3 and the core feet 10, which bound the channel recesses 4.2 and 5.2 along the x-axis X and the y-axis Y, respectively. The antenna core 1, which is in the form of a hollow core, has a minimum wall thickness S in the range of 1 to 3 mm in these channel recesses 4.3, 5.3.

There are respective further channel recesses 4.2, 5.2 on the underside 1.2 of the antenna core 1 between each two adjacent channel feet 10. In these channel recesses 4.2, 5.2, the coil winding 101.2, 102.2 can be guided along the underside 1.2 of the antenna core 1.

Corresponding channel recesses 4.1, 5.1 can also be found on the topside 1.1 of the antenna core 1. These channel recesses 4.1, 5.1 extend between two adjacent edge posts 3. The coil winding 101.2 or 102.2 can be guided along the topside 1.1 of the antenna core 1 by two mutually aligned channel recesses 4.1 or 5.1.

The channel recesses 4.1, 4.2, 4.3 and the channel recesses 5.1, 5.2, 5.3 together form a coil region 4 and 5 respectively, which extends circumferentially around the antenna core 1. The coil regions 4 and 5 run essentially orthogonally to each other, so that the coil windings 101.2, 102.2 are also essentially orthogonally oriented relative to each other.

The orthogonal coil windings 101.2, 102.2 intersect when passing through the two coil regions 4, 5 on the topside 1.1 and the underside 1.2 of the antenna core 1. However, a reciprocal penetration of the coil windings 101.2 and 102.2 is not desired in terms of fabrication or for later operation. For this reason, the coil regions 4, 5 are designed in such a way that they lead the coil windings 101.2, 102.2 along the topside 1.1 and the underside 1.2 with an axial offset to each other along the z-axis Z. As can be seen in particular in FIGS. 1a, 1c and 1d, the channel recesses 5.1 and 5.2 are made less deep for this purpose than the channel recesses 4.1 and 4.2. In this way, the coil winding 101.2, which is the first of the coil windings 101.2, 102.2, 103.2 wound around the antenna core 1, is guided along the channel recesses 4.1 and 4.2 closer to the center of the antenna core 1. The coil winding 102.2 guided in the channel recesses 5.1, 5.2, which is wound only after the coil winding 101.2 and the antenna core 1, is wound in this way along the z-axis Z seen above the coil winding 101.2. Due to the shallower channel recesses 5.1 and 5.2 compared to the channel recesses 4.1 and 4.2, the coil winding 102.2 is nevertheless supported by the channel recesses 5.1 and 5.2 of the antenna core 1, so that the coil winding 102.2 does not exert any force on the coil winding 101.2 which is located below it on the antenna core side along the z-axis Z. The difference in the depth of the channel recesses 5.1, 5.2 relative to the channel recesses 4.1 and 4.2 is in the range of the diameter of the wire 111 used, so that despite this difference of the coil regions 4, 5, the coil windings 101.2 and 102.2 can be substantially the same.

In order to protect or safeguard the wire 111, 112, 113 against damage when winding on the antenna core 1, the edges 1. Of the antenna core 1 are deburred. In particular in the coil regions 4, 5, 9, in which the wire 111, 112, 113 of the coil windings 101.2, 102.2, 103.2 is wound over edges 1.5, this deburring can be seen in the figures as a chamfer or a rounding of the edges 1.5.

In addition to the geometries already described, the antenna core 1 has other production-supporting geometries, which can be seen in particular in FIGS. 1d, 1e to FIG. 4. These production-supporting geometries serve to improve automation in the production of the 3D antenna 100 and at the same time allow higher precision in its production.

On the underside 1.2 of the antenna core 1 there are again three centering grooves 15. These are arranged on the underside 1.2 of the core feet 10 and run from the corners of the underside 1.2 inwards towards the middle of the underside 1.2. Two centering grooves 15 arranged at diagonally opposite corners of the underside 1.2 are formed to be aligned with each other so that together they form a diagonal groove.

Since there is no material of the antenna core 1 in the region between the core feet 10 due to the design of the antenna core 1 as a hollow core with an open underside 1.2, this diagonal centering groove 15 can only be formed section-by-section as a diagonal groove.

The centering grooves 15 are designed in such a way that they can be held as a centering aid by a centering means of a winding device when winding the wire 111, 112, 113. It may be provided that not all centering grooves 15 are used as a centering aid at the same time. For example, a respective centering groove 15 can interact with a corresponding centering means for centering the antenna core 1 during the winding of a single wire 111, 112, 113. In this way, a centering groove 15 can be used for centering during winding of one of the total of at least three coil windings 101.2, 102.2, 103.2. In particular, for winding the wire 113, the centering grooves 215 can hold the coil core 7 at a position in the plane of the x-axis X and y-axis Y. The antenna core 1 can be repositioned after winding each of the coil windings 101.2, 102.2, 103.2 in the winding device, wherein then a different centering groove 15 is used to center the antenna core 1 and interacts with the centering means.

Several receiving grooves 12, each of which can accommodate a starting end of a wire 111.1, 112.1, 113.1, are provided on the underside 1.2 of the antenna core 1. The receiving grooves 12 are implemented underneath the core feet 10. Each of these receiving grooves 12 is associated with a winding-on point 11. The receiving groove 12 is oriented in such a way that the wire 111, 112, 113, whose starting end 111.1, 112.1, 113.1 is received by the receiving groove 12, is guided towards the winding-on point 11 associated with it. The receiving groove 12 is essentially arranged at an angle to a centering groove 15 which is arranged near it.

Guide grooves 13 are also arranged on the underside 1.2 of the antenna core 1 and are each associated with a winding-on point 11. The guide grooves 13 are implemented underneath the core feet 10. These winding-on points 11 associated with the guide groove 13 are those winding-on points 11 with which a receiving groove 12 is also associated. Half of the winding-on points 11 are thus associated with both a guide groove 13 and a receiving groove 12. By means of the guide groove 13, a wire 111, 112, 113 coming from the winding-on point 11 can be guided over the starting end of the wire 111.1, 112.1, 113.1 located in the receiving groove 12 to fix it. Furthermore, the wire 111, 112, 113 in the guide groove 13 is guided from the winding-on point 11 towards the coil region 4, 5, 9. Slipping of the wire 111, 112, 113 on the underside 1.2 of the antenna core 1 is thus avoided.

The winding-on points 11, with which neither a guide groove 13 nor a receiving groove 12 is associated, is associated with a guide groove 14 on the underside 1.2 of the antenna core 1. The guide grooves 14 are implemented underneath the core feet 10. These guide grooves 14 are used to guide the wire 111, 112, 113 away from the coil region 4, 5, 9 to the respective winding-on point 11.

The guide grooves 14 are associated in the exemplary embodiment shown with the winding-on points 11 of the winding-on point type 11b, while the guide grooves 13 and the receiving grooves 12 are associated with the winding-on points 11 of the winding-on point type 11a.

The antenna core 1 has a notch 6 at a corner of one of the edge posts 3. This notch 6 is used for engagement by a winding device in order to be able to guide the coil winding 103.2 running parallel to the z-axis Z as close as possible along the surface of the coil region 9 during winding. The notch 6 essentially includes or consists of two surfaces 6.1, 6.2 arranged at an angle to each other. The surface 6.1 runs along the z-axis Z of the antenna core 1 from the topside 1.1 towards the underside 1.2 and inclined to the outside of the antenna core. In this way, the notch 6 in the upper region of the antenna core 1 is deeper than further towards the underside 1.2. The second side 6.2 of the notch 6 is additionally twisted around the z-axis Z relative to the first side 6.1. The second surface 6.2 is shorter along the z-axis Z than the first surface 6.1, so that the notch 6 tapers along the z-axis Z towards the underside 1.2.

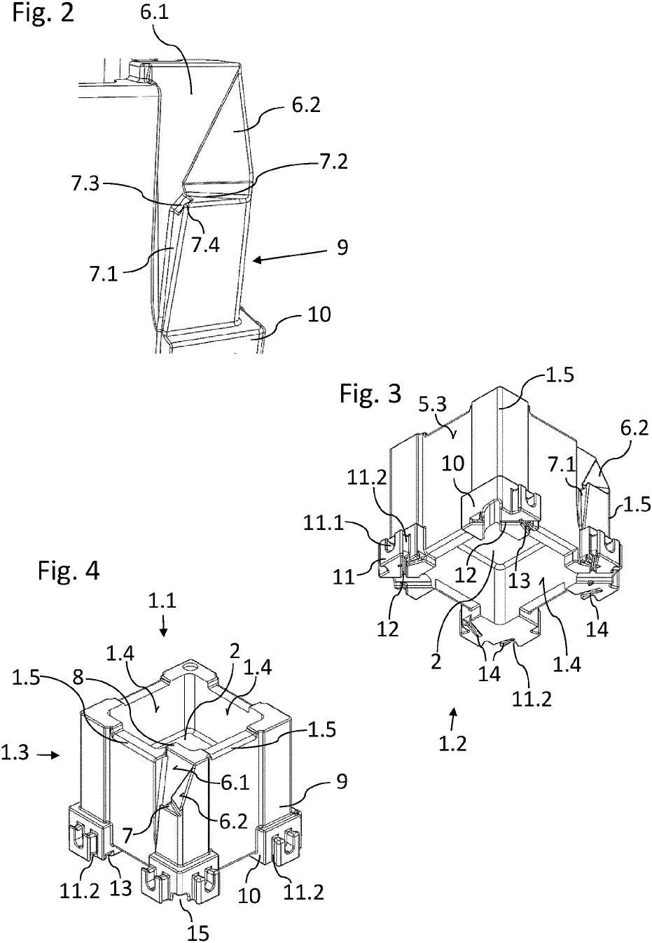

In an end region of the notch 6 bearing towards the underside 1.2, a guide region 7 is provided, which can be seen in particular in FIG. 2 to FIG. 4. This guide region 7 is divided into several guide sections 7.1, 7.2, 7.3 and is essentially L-shaped or hook-shaped. The guide region 7 serves to guide the wire 113 from the winding-on point 11 to the upper end of the coil region 9, which is bounded by the guide section 7.2 along the z-axis Z towards the topside 1.1. The guide sections 7.1, 7.2 of the guide region 7 have an inclination directed towards the inside of the antenna core. Apart from this inclination directed towards the inside of the antenna core, the first guide section 7.1 essentially runs along the z-axis Z with a small angular offset in the range less than 10°. The second guide section 7.2 essentially runs in an x-y plane parallel to the x-axis X and the y-axis Y. In this x-y plane, the second guide section 7.2 is inclined towards the inside of the antenna core.

To deburr the edge between the guide sections 7.1, 7.2, the guide region 7 has a third, short guide section 7.3. This guide section 7.3 is essentially in the form of a type of chamfer. In the region of this guide section 7.3, the guide region 7 additionally has a nose 7.4, which protects a wire 113 guided along the guide section 7.3 against slipping.

Before winding the coil winding 103.2 around the coil region 9, the wire 113 is guided along the guide region 7 from the winding-on point 11 to the coil region 9. In order to guide the wire 113 along the guide region 7, a winding device engages in the notch 6, at the lower end of which the guide region 7 adjoins.

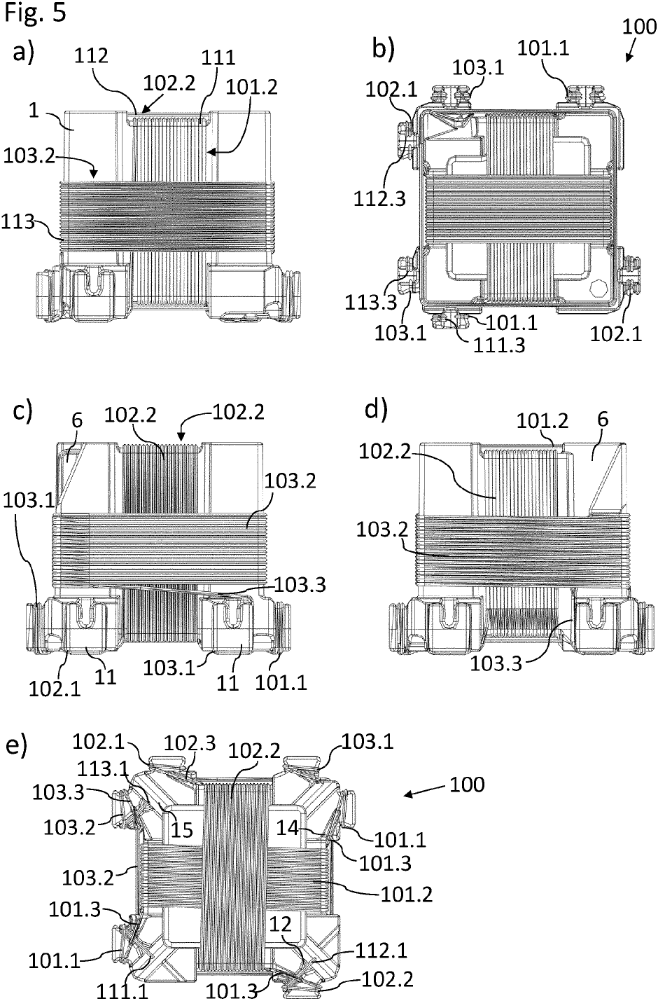

FIGS. 5a to 5e show a 3D antenna 100 with an antenna core 1 of a further embodiment, which, unless otherwise described below, has the same design and functional features as the first embodiment. The respective perspectives of FIGS. 5a to 5e as well as the orientations of the axes X, Y, Z of the 3D antenna 100 correspond to those perspectives and orientations of the axes X, Y, Z as they have already been described above for the antenna core 1 in FIG. 1.

Unlike the antenna core 1 shown in FIG. 1, the antenna core 1 in FIG. 5 is wound with electrically conductive wire 111, 112, 113, so that an entire 3D antenna 100 is represented here. The coil windings 101.2, 102.2, 103.2 each form a part of an antenna winding 101, 102, 103, each of which has a wire binding 101.1, 102.1, 103.1 in its start and end regions. In addition, transition windings 101.3, 102.3, 103.3 belong to the antenna windings 101, 102, 103 for connecting the coil windings 101.2, 102.2, 103.2 to one of the wire bindings 101.1, 102.1, 103.1.

During the production of the 3D antenna 100, a first wire 111 is first wound onto one of the winding-on points 11, the wire 111 with a transition winding 101.3 is guided to the coil region 4, the coil winding 101.2 is wound, the wire 111 with a further transition winding 101.3 is guided to a second winding-on point 11 and then a second wire binding 101.1 is wound on at the second winding-on point 11. Subsequently, analogously, winding on of the second wire 112 at a winding-on point 11 is carried out by making a first wire binding 102.1 of this antenna winding 102, before the coil winding 102 is then also wound and the wire 112 is wound onto another winding-on point 11. Likewise, the winding on of the third wire 113 at a winding-on point 11 is carried out with a wire binding 103.1, then winding of the coil winding 103.2 is carried out and final winding of the wire 113 is carried out at another winding-on point 11 with a wire binding 101.1.

For producing these antenna windings 101, 102, 103 the antenna core 1 also has centering grooves 15 on its underside 1.2. These centering grooves 15 are oriented in pairs along the diagonals of the underside 1.2 and aligned with each other, so that each centering groove pair forms an interrupted, section-by-section diagonal groove. The two pairs, each forming a diagonal centering groove 15, are essentially arranged perpendicular to each other, so that as a whole they form a crossed groove for centering the antenna core 1.

The centering grooves 15, as shown in FIG. 5e, are not covered by the wire 111, 112, 113 of one of the antenna windings 101, 102, 103. Therefore, the centering grooves 15 can center the antenna core 1 not only during the production of the antenna windings 101, 102, 103, but can also be used to center the entire 3D antenna 100 during the installation thereof. For this purpose, the centering grooves 15 can engage with appropriate centering means, for example protrusions of a circuit board on which the 3D antenna 100 is to be installed.

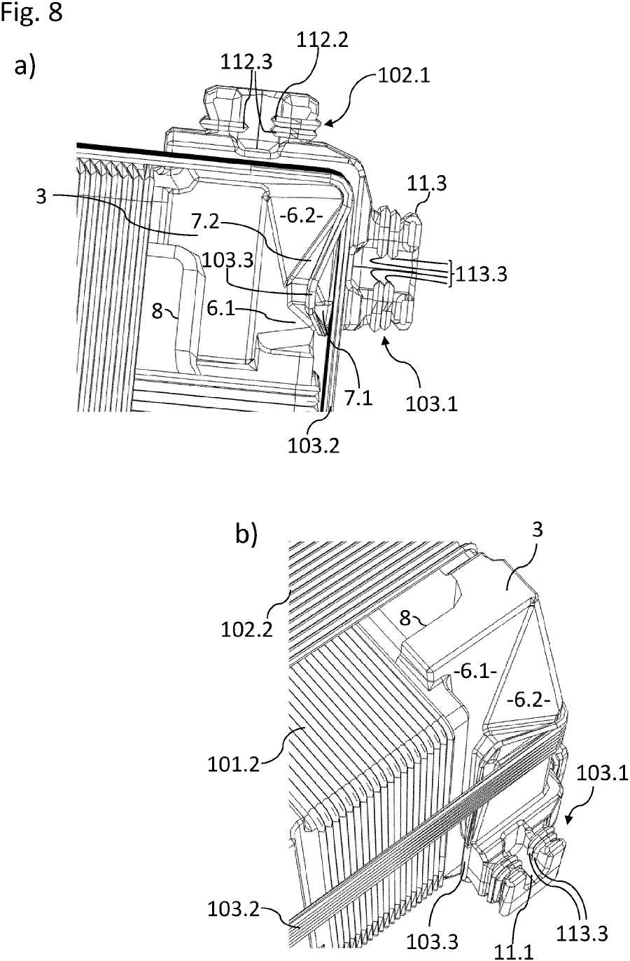

FIG. 5c shows one of the transition windings 103.3 of the antenna winding 103, which extends diagonally from the coil winding 103.2 over one of the outer sides 1.3 of the antenna core 1 towards the wire binding 103.1 wound around a winding-on point 11. The antenna winding 103 has a further transition winding 103.3, which however is largely covered by the coil winding 103.2 in FIG. 5d. This second transition winding 103.3 will be explained in more detail below in connection with FIG. 7 and FIG. 8.

FIG. 5e shows the corresponding starting ends of wires 111.1, 112.1, 113.1 accommodated in the receiving grooves 12, as well as the wires 111, 112, 113 of the transition windings 101.3, 102.3, 103.3 in the guide grooves 13 and 14. The receiving grooves 12 and the guide grooves 13 and 14 are formed analogously to those shown in FIG. 1.

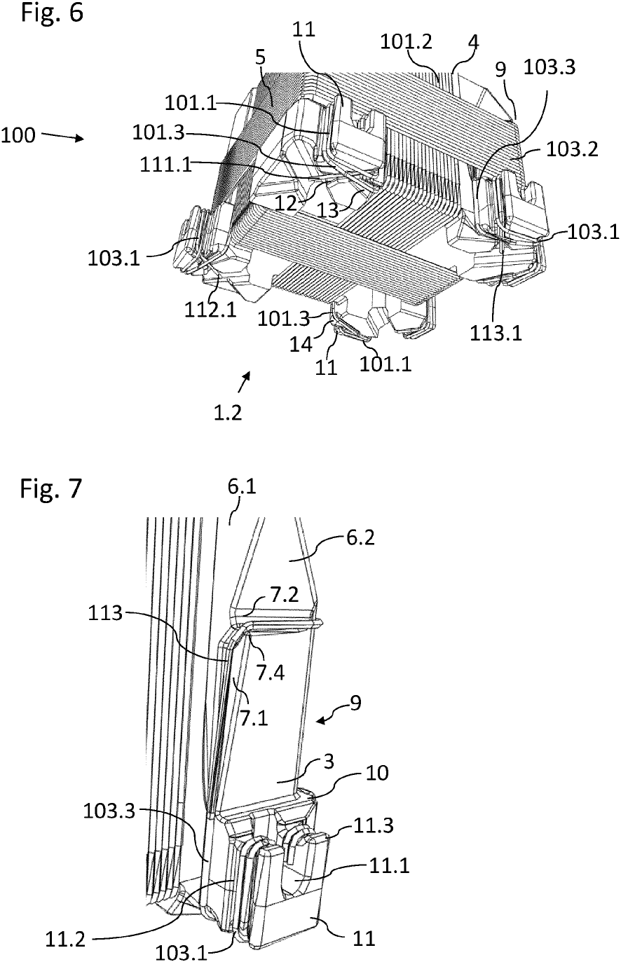

FIG. 6 shows the guidance of the wires 111, 112, 113 on the underside 1.2 of the antenna core 1 and thus the underside 1.2 of the 3D antenna 100 in more detail. As can be seen, the starting end of the wire 111.1, 112.1, 113.1 is accommodated in the receiving groove 12. The wire 111, 112, 113 is guided from there towards the winding-on point 11 and is wound around its circumferential groove 11.2 in order to produce the wire binding 101.1, 102.1, 103.1 of the antenna winding 101, 102, 103 in this way. The wire 111, 112, 113 coming from the winding-on point 11 then forms a transition winding 101.3, 102.3, 103.3. This transition winding 101.3, 102.3, 103.3 is wound over the starting end of the wire 111.1, 112.1, 113.1 accommodated in the receiving groove 12 and guided through a guide groove 13 towards the coil region 4, 5, 9. Due to this wire guidance of the transition winding 101.3, 102.3, 103.3, the starting end of the wire 111.1, 112.1, 113.1 is reliably fixed in the receiving groove 12. Due to the wire binding 101.1, 102.1, 103.1 and the fixing of the starting end of the wire 111.1, 112.1, 113.1, the wire 111, 112, 113 is reliably attached to the antenna core 1.

In order to be able to establish an electrically conductive connection of the wire 111, 112, 113 and thus the coil windings 101.2, 102.2, 103.2 to a circuit in which the 3D antenna 100 is installed when installing the 3D antenna 100, the wire 111, 112, 113 can be metallized in particular in the antenna underside region of the wire bindings 101.1, 102.1, 103.1. This is not shown in the figures shown for reasons of better visibility of the wire guidance. In addition to the wire bindings 101.1, 102.1, 103.1, the starting ends of the wires 111.1, 112.1, 113.1 as well as the regions of the transition windings 101.3, 102.3, 103.3 located on the underside 1.2 can also be metallized.

The wire guidance in the region of the winding-on points 11, around which the wire bindings 101.1, 102.1, 103.1, which complete the antenna winding 101, 102, 103 production, are wound only after the completion of the coil windings 101.2, 102.2, 103.2, differs slightly from the wire guidance in the region of the winding-on point 11 associated with a receiving groove 12 for the starting end of the wire 111.1, 112.1, 113.1. Such a wire binding 101.1 produced to complete the antenna winding 101 is shown in the rear region of the 3D antenna 100 shown in perspective in FIG. 6. There, the wire guidance of the wire 111 of the transition winding 101.3 on the underside 1.2 takes place only in the guide groove 14 towards the wire binding 101.1. The wire end 111.2 is not received there in a receiving groove 12, but, as cannot be seen in FIG. 6, is received by the winding-on recess 11.1 of the winding-on point 11.

While the transition windings 101.3, 102.3 of the antenna windings 101, 102 running along the x-axis X or y-axis Y are comparatively short, the antenna winding 103 has a comparatively longer transition winding 103.3 from the wire binding 103.1 at the winding-on point 11 associated with the receiving groove 11 to the coil winding 103.2 wound around the coil region 9. This transition winding 103.3 runs partially under the coil winding 103.2 of the same antenna winding 103. This is shown in more detail in FIG. 7.

FIG. 7 does not show the coil winding 103.2 around the coil region 9. This corresponds to a state during the production of the 3D antenna 100 in which the two antenna windings 101 and 102 have already been completely wound on the antenna core 1, but of the antenna winding 103 initially only the wire binding 103.1 has been wound around the winding-on point 11 and the transition winding 103.3 from this first wire binding 103.1 to the coil region 9 has been completed.

As can be seen, the wire 113 in the transition winding 103.3 is initially guided away from the underside 1.2 essentially parallel to the z-axis Z of the 3D antenna 100. The wire 113 of the transition winding 103.3 is guided via the guide region 7 to the coil region 9 of the antenna core 1. The wire 113 rest against the nose 7.4, which holds it in position. Due to the course of the guide section 7.1 already described above pointing towards the inside of the antenna core and the course of the guide section 7.2 leading out again, the wire 113 of the transition winding 103.3 is guided over the guide region 7 essentially in the manner of an arc along a curvature of the surface of the antenna core 1. This guidance makes it possible for the coil winding 103.2 to be wound over the coil region 9 and over the transition winding 103.3 guided through the guide region 7. The transition winding 103.3 is additionally secured by the coil winding 103.2 in this way during the production of the 3D antenna 100, so that it cannot detach, which could otherwise lead to unwinding of the antenna winding 103.

In FIG. 8a and FIG. 8b, this guidance of the wire 113 over the guide region 7 is shown from different perspectives. In particular in FIG. 8a, the guidance of the wire 113 of the transition winding 103.3 in the manner of an arc inside the antenna can be clearly seen. FIG. 8 also shows the coil winding 103.2, which additionally fixes the transition winding 103.3, in a not finally completed state.

FIG. 8 also shows the notch 6 with the two surfaces 6.1 and 6.2, which allows engagement by a winding device for guiding the wire 113 of the transition winding 103.3 over the guide region 7. In the region of the notch 6, the inner side 1.4 of the antenna core 1 has an inner protrusion 8, which serves the additional stabilization of the antenna core 1 in the region of the notch 6. Since material of the antenna core 1 for making the notch 6 is removed or is not present from the beginning, there would be a decrease of the wall thickness S of the antenna core 1 in the region of this notch 6. This is compensated by the additional antenna core material of the inner protrusion 8.

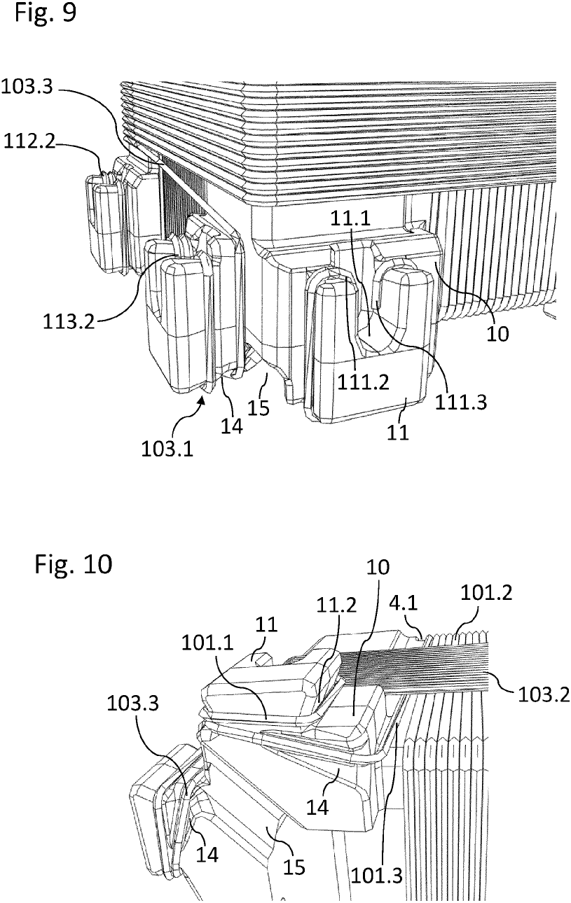

FIG. 9 and FIG. 10 again show winding-on points 11 of the 3D antenna 100. These winding-on points 11 are those winding-on points 11 around which the wire bindings 101.1, 102.1, 103.1 terminating the antenna windings 101, 102, 103 are wound with the corresponding wire ends 111.2, 112.2, 113.2. The wire guidance of the wires 111, 112, 113 corresponds to the wire guidance of the corresponding wire binding 101.1 already described in connection with FIG. 6.

FIG. 10 shows once again the guidance of the wire 111 in the region of the transition winding 101.3 coming from the coil winding 101.2 to the wire binding 101.1. The wire 111 of the transition winding 101.3 initially coming from the coil winding 101.2 is guided essentially along the z-axis Z towards the underside 1.2. There, the transition winding 101.3 is guided via the guide groove 14 introduced in the core foot 10 to the winding-on point 11. The wire 111 is wound around the winding-on point 11 in the circumferential groove 11.2 thereof, so that the wire binding 101.1 is guided.

As shown in FIG. 9 and already in FIG. 8a, in the wire bindings 101.1, 101.2, 101.3 that terminate the antenna windings 101, 102, 103, the respective wire end 111.2, 112.2, 113.2 is received by the winding-on recess 11.1 of the winding-on point 11. For this purpose, the wire end 111.2, 112.2, 113.2 is bent into the slot-shaped winding-on recesses 11.1 formed by the U-shaped winding-on points 11.

As can be seen, the wire bindings 101.1, 102.1, 103.1 are formed in the manner of open wire bindings. The wire 111, 112, 113 is first wound around the winding-on point 11 in the circumferential groove 11.2 to produce them. Subsequently, the individual wire loops of the wire binding 101.1, 102.1, 103.1 resulting from this are severed so that wire openings 111.3, 112.3, 113.3 result in the region of the wire binding 101.1, 102.1, 103.1. Because of these wire openings 111.3, 112.3, 113.3, stray inductances of the wire binding 101.1, 102.1, 103.1, which affect the quality of the 3D antenna 100 negatively, are avoided, since the conductor loop-like wire loops are interrupted. In particular, when using a thin wire 111, 112, 113, i.e. with a wire diameter of less than 300 µm, the wire bindings 101.1, 102.1, 103.1 are metallized before the severing in the region of the wire openings 111.3, 112.3, 113.3 to be produced, so that the individual wire loops of the wire bindings 101.1, 102.1, 103.1 stabilize each other during the severing.

The wire openings 111.3, 112.3, 113.3 are pressed into the winding-on recess 11.1 of the winding-on point 11. An engagement stabilizing the wire openings 111.3, 112.3, 113.3 is produced in this way. The severing of the wire 111, 112, 113 of the wire bindings 101.1, 102.1, 103.1 can be carried out in a combined work step together with the pressing of the wire openings 111.3, 112.3, 113.3 into the winding-on recesses 11.1. For this purpose, a plunger-shaped separating tool in the form of a punch can be inserted into the winding-on recess 11.1, so that this, together with the winding-on recess 11.1 acting in the manner of a die, separates the wire 111, 112, 113 of the wire bindings 101.1, 102.1, 103.1 accordingly and shapes it at the same time.

With the 3D antenna 100 described above and with the help of the described method, a 3D antenna.

Reference characters

| | |
|---|---|
| 1 | Antenna core |
| 1.1 | Topside |
| 1.2 | Underside |
| 1.3 | Outer side |
| 1.4 | Inner side |
| 1.5 | Edge |
| 2 | Stabilizing floor |
| 3 | Edge post |
| 4 | Coil region |
| 4.1 | Channel recess |
| 4.2 | Channel recess |
| 4.3 | Channel recess |
| 5 | Coil region |
| 5.1 | Channel recess |
| 5.2 | Channel recess |
| 5.3 | Channel recess |
| 6 | Notch |
| 6.1 | Surface |
| 6.2 | Surface |
| 7 | Guide region |
| 7.1 | Guide section |
| 7.2 | Guide section |
| 7.3 | Guide section |
| 7.4 | Nose |
| 8 | Inner protrusion |
| 9 | Coil region |
| 10 | Core foot |
| 11 | Winding-on point |
| 11a, b | Types of winding-on point |
| 11.1 | Winding-on recess |
| 11.2 | Circumferential groove |
| 11.3 | Fold |
| 12 | Receiving groove |
| 13 | Guide groove |
| 14 | Guide groove |
| 15 | Centering groove |
| 100 | 3D Antenna |
| 101 | Antenna winding |
| 101.1 | Wire binding |
| 101,2 | Coil winding |
| 101.3 | Transition winding |
| 102 | Antenna winding |
| 102.1 | Wire binding |
| 102.2 | Coil winding |
| 102.3 | Transition winding |
| 103 | Antenna winding |
| 103.1 | Wire binding |
| 103.2 | Coil binding |
| 103.3 | Transition winding |
| 111 | Wire |
| 111.1 | Starting end of a wire |
| 11.2 | Wire end |
| 11.3 | Wire opening |
| 112 | Wire |
| 112.1 | Starting end of a wire |
| 112.2 | Wire end |
| 112.3 | Wire opening |
| 113 | Wire |
| 113.1 | Starting end of a wire |
| 113.2 | Wire end |
| 113.3 | Wire opening |
| LA1 | Longitudinal axis |
| LA2 | Longitudinal axis |
| X | x-axis |
| Y | y-axis |
| Z | z-axis |

Having described the invention in detail and by reference to the various embodiments, it should be understood that modifications and variations thereof are possible without departing from the scope of the claims of the present application.

What is claimed is:

1. A 3D antenna having three essentially mutually orthogonally arranged coil windings of electrically conductive wire and a ferromagnetic antenna core with coil regions for accommodating the coil windings, wherein
winding-on points for winding on the wire onto the antenna core are formed in one piece with the antenna core.

2. The 3D antenna as claimed in claim 1, wherein the antenna core is in the form of a one-piece hollow core.

3. The 3D antenna as claimed claim 1, wherein the coil windings are parts of antenna windings which have wire bindings and at least one transition winding for connecting the coil winding to one of the wire bindings.

4. The 3D antenna as claimed in claim 1 wherein the winding-on points are stud-shaped with a U-shaped cross-section.

5. The 3D antenna as claimed in claim 1 wherein the antenna core has at least one production-supporting geometry including a stud, a groove, a notch and/or a recess.

6. The 3D antenna as claimed in claim 1, wherein the antenna core has a centering aid including a centering groove arranged diagonally and/or on an underside of the antenna core.

7. The 3D antenna as claimed in claim 1, wherein at least one transition winding of the wire runs partially under one of the coil windings.

8. The 3D antenna as claimed in claim 1, wherein the antenna core has a guide region for guiding the wire to one of the coil regions and under one of the coil windings on the antenna core side.

9. The 3D antenna as claimed in claim 8, wherein the guide region has at least two guide sections.

10. The 3D antenna as claimed in claim 1, wherein protrusions, including core feet, bound the coil regions in at least one direction.

11. The 3D antenna as claimed in claim 1, wherein at least one of the coil regions is formed in the manner of a coil channel.

12. The 3D antenna as claimed in claim 1, wherein the antenna core is made of sintered ferrite.

13. The 3D antenna as claimed in claim 1, wherein at least one wire binding is metallizedon the underside of the antenna core.

14. A method for producing a 3D antenna having three essentially mutually orthogonally arranged coil windings of electrically conductive wire and a ferromagnetic antenna core with coil regions for accommodating the coil windings wherein the wire is wound onto winding-on points formed in one piece with the antenna core.

15. The method as claimed in claim 14, wherein a winding device engages in a notch at a corner of the antenna core during winding of at least one antenna winding.
